(19) United States
(12) Patent Application Publication
(10) Pub. No.: US 2005/0160066 A1
(43) Pub. Date: Jul. 21, 2005

(54) Database and cataloging system for object manipulations

(76) Inventor: Laurence J. Shaw, San Francisco, CA (US)

Correspondence Address: Laurence J. Shaw, 3627 Sacramento Street, San Francisco, CA, 94118, US

(21) Appl. No.: 10/963,690

(22) Filed: Oct. 13, 2004

Related U.S. Application Data
(60) Provisional application No. 60/512,276, filed on Oct. 17, 2003.

(51) Int. Cl. G06F 7/00

(52) U.S. Cl. 707/1

(57) ABSTRACT

A database for maneuvers performed by a player with an object using a cataloging system providing a many-to-one mapping of maneuvers to library codes. A library code is a sequence of code groups reflecting a sequence of changes in contact of the object with itself, the player, and environmental surfaces. Each code group is constructed of code characters for (i) parts of the object, (ii) parts of the player's body, (iii) modes of motion of the object, and (iv) types of changes in contact. There are no code characters for other aspects of the player's movements. A point of contact on an extended portion or component of the object is indicated by appending code characters corresponding to boundary points to the code character representing the extended portion or component. Specifier characters may be appended to code characters to provide information such as direction or orientation.

### BACKGROUND OF THE INVENTION

The present invention relates to databases and indexing systems for data in databases, and still more particularly to databases with indexing systems for data describing object manipulations.

Object manipulations such as yo-yo tricks, baton spins, lasso maneuvers, etc. can be quite complex, and therefore difficult to describe and categorize. (For ease of discussion in the present specification, object manipulations will be referred to as tricks.) For a particular object, if one has developed a trick and is wondering whether it has been developed before, or if one has produced a detailed description or animation of a trick and wants to make sure that others can find it, or if one wants to learn about certain types of tricks, it is useful to have a database where tricks can be easily cataloged, stored, searched for, and retrieved. However, with an object which has many degrees of freedom and/or with which complex manipulations can be performed, the indexing of tricks is problematic.

### BRIEF DESCRIPTION OF THE DRAWINGS

FIG. 1 is a depiction of a computer network which includes the database of the present invention.

FIG. 2 shows a swinging ball toy for which maneuvers may be cataloged and stored according to the present invention.

### DETAILED DESCRIPTION OF THE PRESENT INVENTION

The present invention provides a tricks database with a simple, but useful, cataloging system. The cataloging system is useful because (1) the generation of library codes is based on simple rules, and (2) although the mapping of tricks to library codes is not a one-to-one mapping, it is a mapping which provides tricks which are similar with the same library code, yet does not provide too large a number or too wide a variety of tricks with the same library code.

The play object to which the present invention may be applied may be:
a toy, such as a yo-yo or swinging ball toy;
an object used for sports, exercise, recreation, or martial arts, such as a jump rope or nunchackus;
an object which serves a useful purpose, such as a lasso;
an object used for performances, such as a baton or juggling equipment; etc.
   Details of the Database

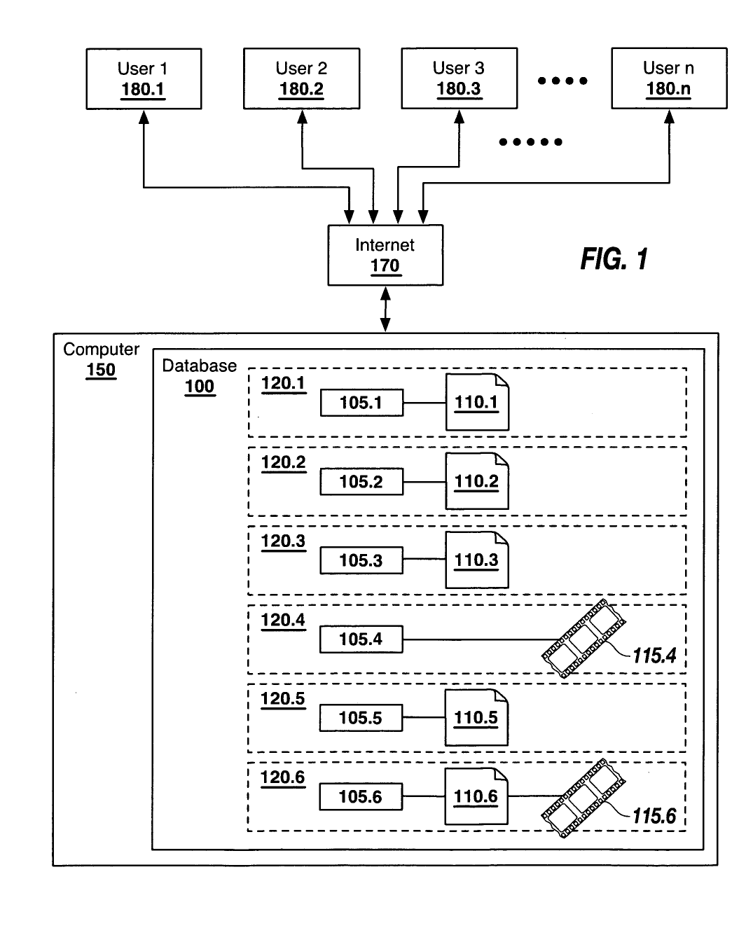

As shown in FIG. 1, the preferred embodiment of the present invention consists of a variable plurality n of users (180) which are connected via the Internet (170) to a computer (150) which has a database (100) containing entries (120) which have written descriptions (110) and/or video or animated depictions (115) of maneuvers which players can perform with a play object. (Similar elements of FIG. 1 will be referred to collectively or generally using a three-digit reference numeral, but particular ones of the similar elements will be referred to with a three-digit reference numeral followed by a decimal point and an additional digit.) The entries (120) of the database (100) are assigned library codes (105) which may not be unique. (Therefore, it should be noted that the library codes (105) are not actually the indices of the database entries.) The exemplary database (100) shown in FIG. 1 is depicted as having written descriptions (110.1), (110.2), (110.3), (110.5) and (110.6) and video or animated depictions (115.4) and (115.6). It should be noted that some entries, such as entry (120.6) in FIG. 1, may have both a written description (110.6) and a video or animated description (115.6).

The software of the database (100) of the present invention allows written descriptions (110), videos (115), and/or animations (115) of tricks to be uploaded by a user (180) to the database (100) using techniques well-known in the art of database and Internet technologies. The software of the database (100) also allows a user (180) to view the entries (120). Either a user (180) can peruse an alphabetical ordering of the entries (120), or a user (180) can perform a search to find entries (120) of particular interest. According to the preferred embodiment, the search engine of the database (100) allows the user (180) to use the following operators:
AND—the Boolean “and” operator
OR—the Boolean “or” operator
XOR—the Boolean “exclusive or” operator
NOT—the Boolean “not” operator
ORD—items must be ordered as specified
Wn—the items on each side of the operator must be within n groups of each other.
x1, x2, x3—wild cards/place holder
a, b, c—variables which may represent numbers
   Examples of searches using these operators are provided below.
   Details of the Cataloging System

According to the system of the present invention, object manipulations (i.e., “tricks”) are cataloged using a cataloging system which has a many-to-one or many-to-few mapping between tricks and library codes. A library code is an ordered sequence of code groups reflecting the time sequence of changes in contact of the object with itself, the player, and environmental surfaces. Each code group is constructed of code characters for (i) parts of the object, (ii) parts of the player's body, (iii) modes of motion of the object, and (iv) types of changes in contact. There are no code characters for other aspects of the player's movements, i.e., the library code contains no information regarding what motions of the player are required to produce the sequence of changes in contact.

(In the present specification, a change in contact will be referred to as a “CHIC,” a part of the play object will be referred to as an “POP,” a part of a player's body will be referred to as an “BOP,” a mode of motion of the object will be referred to as a “MOM,” and an environmental surface will be referred to as a “ENV.”)

That the library codes contain no information about the motions of the player, other than the CHIC and MOM information, is an important aspect of the present invention. Because of the many degrees of freedom which the body of a player has, the many degrees of freedom which a play object may have, and the large number of possibilities regarding the temporal relationships between player motions and motions of the object, this greatly reduces the number of code characters required, as well as the complexity of the system used to map tricks to library codes. However, this simplification means that the library code for a trick is not a description of the trick, and the mapping of tricks to library codes is a many-to-one or many-to-few mapping. Therefore, for a particular library code there may be a plurality of corresponding maneuvers.

A point of contact on an extended portion or component of the object is indicated by appending code characters corresponding to boundary points to the code character representing the extended portion or component. Specifier characters may also be appended to code characters to provide information such as direction or orientation.

Cataloging System for Swinging Bob Toy Tricks

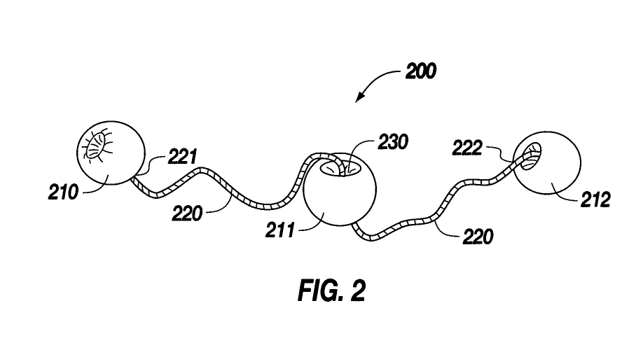

As shown in FIG. 2, a swinging bob toy 200 consists of three bobs (210), (211) and (212) on a string (220) with the two end bobs (210) and (212) fixed at the ends (221) and (222), respectively, of the string (220) and the middle bob (211) having a throughbore (230) through which the string (220) passes to that the middle bob (211) is slideably mounted on the string (220) between the two end bobs (210) and (212).

A library code is a string of letters and numbers (and parentheses, hyphens, and commas) representing the sequence of CHICs and MOMs that occur when performing a trick. The table below provides code characters for a library system for the swinging bob toy according to a preferred embodiment of the present invention:

POP CODES:

B1—First end ball (generally, at least at the beginning of a trick, the end ball which is held)
B2—Middle ball
B3—Second end ball (generally, at least at the beginning of a trick, the end ball which is not held)
S—string
   BOP CODES:
C—torso
D—shoulder
E—arm
F—finger, hand
G—leg
J—foot
K—neck, head
   ENV CODES:
L—flat surface
   MOM CODES:
O—orbit of two separated balls, or three balls if toy is in mid-air
Q—swing of a single end ball, or the middle ball and an end ball together, or the middle ball with the end balls held
Z—slide of middle ball along string
   CHIC CODES:
T—initiation of non-restraint contact
U—termination of non-restraint contact
W—bounce
X—initiation of restraint contact, e.g., grasp, pinch, squeeze, catch, hold, etc.
Y—termination of restraint contact, e.g., release, toss, drop, etc.
   SPECIFIER CODES:
r—right {for instance, Fr=right hand or right fingers}
p—left {for instance, Gp=left leg}
v—vertical {for instance, Ov=vertical orbit; Lv=vertical surface, such as a wall; Qv=swing of a ball or balls vertically}
h—horizontal {for instance, Oh=horizontal orbit; Lh=horizontal surface, such as the floor, ceiling, or table; Qh=swing of a ball or balls horizontally; Lhv=a non-flat surface, such as a rail, bar, or post}

According to the present invention, for an extended component of the object (i.e., a component which has a dimension which is large relative to the size of contact area between said component and either the player, an environmental surface, or another component of the object) the location of a point of contact on the extended component is detailed by specifying surrounding points where ENVs, POPs, and BOPs are in contact with the extended component. For instance, the string is an extended one-dimensional physical component of the swinging bob toy, so a location on the string is detailed by specifying two boundary points. According to the present invention, the location of a point of contact on the string is detailed by specifying a pair of POP codes, or a pair of BOP codes, or a pair of ENV codes, or a POP code and a BOP code, or a POP code and an ENV code, or a BOP code and an ENV code in parentheses following the POP code “S” for the string. For instance, S(B1,B2) is the portion of the string between the first end ball B1 and the middle ball B2, and contact of the right hand with that portion of the string would be specified with the code group: Fr-T-S(B1,B2). Contact of the right hand with that portion of the string would then provide two regions in the string between the first end ball B1 and middle ball B2, and these two regions have the POP codes S(B1,Fr) and S(B2,Fr). (It should be noted that these two regions could also be specified as S(Fr,B1) and S(Fr,B2). However, according to the present invention, when there are two or more equivalent ways of providing a sequence of codes characters within parentheses, the codes are alphabetized by the software of the database.)

Similarly, the various MOMs are detailed by specifying the POPs involved in the motion. For instance: Ov(B2,B3) is a vertical orbit of the middle ball B2 and the end ball B3; Oh(B1,B2) is a horizontal orbit of the middle ball B2 and the end ball B1; O(B1,B2,B3) is the notation for when the swinging bob toy is in mid-air and all three balls B1,B2 and B3 are orbiting; Qv(B1) is the end ball B1 being swung in a vertical circle; and Qh(B1,B2) is the end ball B1 and middle ball B2, which are located together at the B1 end of the string, being swung in a horizontal circle. Similarly, a number in parentheses after the F code to specify a particular finger: F(1) is the thumb, F(2) is the pointer finger, F(3) is the index finger, etc. A pair of fingers, which for instance are used to pinch the string, are specified by putting two numbers in the parentheses following the F code. For instance, pinching the string between balls B1 and B2 between the thumb and pointer finger would be notated as F(1,2)-X-S(B1,B2). This example illustrates that for BOP/POP CHICs, the ordering of the library codes is BOP-CHIC-POP. Similarly, for ENV/POP CHICs, the ordering of the library codes is ENV-CHIC-POP. For POP/POP CHICs, the ordering of the two POP codes in the sequence POP-CHIC-POP is alphabetical. It should be noted that users need not know these conventions, since the software of the database can reorder the codes of a user's entry upon entering the entry into the database.

For example, an end-ball switch would have a library code of:
Ov(B2,B3)/Fr-Y-B1/Fr-X-B3/Ov(B2,B1)
because the trick (i) begins with a vertical orbit of the middle ball B2 and end ball B3, (ii) the ball B1 which is held in the right hand is released, (iii) the orbiting end ball B3 is caught in the right hand, and (iv) vertical orbiting continues. Notice that a toss-and-catch, which is performed by the sequence of (i) beginning with a vertical orbit of the middle ball B2 and end ball B3, (ii) tossing the end ball B1 up so that the entire toy goes upwards, (iii) catching the end ball B3 with the right hand, and (iv) continuing orbiting, would have the same library code as the end-ball switch. This illustrates, as mentioned above, that a library code only describes CHICs and MOMs, not other motions of the player, so multiple tricks can have the same library code.

As another example, the library code for a wrist flip (which begins with a vertical orbit, followed up having end ball B1 pass over the right arm so that the string contacts the arm, followed by having the middle ball B2 pass over the right arm so that the string leaves contact with the right arm, followed by vertical orbiting) is:
Ov(B2,B3)/Er-T-S(B2,B3)/Er-U-S(B2,B3)/Ov(B2,B3).
It should be noted that according to the present invention it is assumed that the player is right handed and, if holding a single end ball, it is end ball B1 that is held.

As another example, the library code for the maneuver which begins with a horizontal orbit, followed by grabbing the string between the held ball and the middle ball with the left hand, followed by swinging the held ball in a horizontal circle is:
Oh(B2,B3)/Fp-X-S(B1,B2)/Fr-Y-B1/Qh(B1)+Oh(B2,B3).

As described above, searches can be performed using the database (100) of the present invention. For instance, if a user (180) is interested in tricks where the swinging bob toy (200) is swung around the leg, the user (180) would find such tricks by entering “G-T-S” into the search field. Or, if a user (180) is interested in tricks where the swinging bob toy (200) is swung around the leg and also the middle ball is kicked, the user (180) would find such tricks by entering “G-T-S AND J-T-B2” into the search field. Or, if a user (180) is interested in tricks where the swinging bob toy (200) is swung around the leg and also an end ball is kicked, the user (180) would find such tricks by entering “G-T-S AND J-T-(B1 OR B3)” into the search field. Or, if a user (180) is interested in tricks where the swinging bob toy (200) is swung around the leg and afterwards an end ball is kicked, the user (180) would find such tricks by entering “ORD(G-T-S AND J-T-(B1 OR B3))” into the search field. Or, if a user (180) is interested in tricks where a ball is released from a hand but not immediately caught, the user (180) would find such tricks by entering “F-Y-Ba AND w/1 NOT(F-X-Ba)” into the search field.

Thus, it will be seen that the improvements presented herein are consistent with the objects of the invention for a database for object manipulations described above. While the above description contains many specificities, these should not be construed as limitations on the scope of the invention, but rather as exemplifications of preferred embodiments thereof. A wide range of variations are within the scope of the present invention. For example: the “object” may have separable parts, such as juggling balls; other assignments may be made between code characters and MOMs, CHICs, BOPs, POPs and ENVs for the swinging bob toy; other punctuation symbols may be used in place of the punctuation symbols of the above-described cataloging system for the swinging bob toy; additional BOP codes may be used, whereby points of contact would be specified more precisely; fewer BOP codes may be used, whereby points of contact would be specified less precisely; additional POP codes may be used, whereby points of contact would be specified more precisely; fewer POP codes may be used, whereby points of contact would be specified less precisely; additional CHIC codes may be used for additional types of initiation of contact or to more particularly differentiate between types of initiation of contact; additional CHIC codes may be used for additional types of termination of contact or to more particularly differentiate between types of termination of contact—for instance, CHIC codes may differentiate between restraints along one, two or three dimensions; fewer CHIC codes may be used for types of initiation of contact or types of termination of contact; additional MOM codes may be used for additional types of modes of motion or to more particularly differentiate between types of modes of motion; fewer MOM codes may be used for the modes of motion; the swinging bob toy may have just two bobs on the string, i.e., an end bob and a sliding bob; the play object may be another type of toy, such as a yo-yo, devil sticks, or a Diablo; the play object may be an object used for sports, exercise, recreation, or martial arts, such as a jump rope or nunchackus; the play object may be an object which serves a useful purpose, such as a lasso; the play object may be an object used for performances, such as a baton or juggling balls; environmental surfaces with which the object makes contact need not be planar or rigid; users may access the database via channels other than the Internet; there may be a single user rather than a plurality of users; the database may contain only written descriptions or only visual descriptions; etc.

Accordingly, it is intended that the scope of the invention is determined not by the embodiments illustrated or the physical analyses motivating the illustrated embodiments, but, rather, by the appended Claims and their legal equivalents.

1. A database of descriptions of maneuvers performable by a player with an object, each of said descriptions having a library code comprised of an ordered sequence of code groups representing a time-ordered sequence of events associated with a corresponding one of said maneuvers, said events including changes of contact between said player and said object during said one of said corresponding maneuvers.

2. The database of claim 1 wherein said events further include changes of contact between said object with itself during said one of said corresponding maneuvers.

3. The database of claim 2 wherein said events include changes of contact between said object and an environmental surface.

4. The database of claim 2 wherein said library codes are formed from library code characters including object-part characters for parts of said object, player-body-part characters for portions of said player, and change-in-contact characters for types of said changes in contact.

5. The database of claim 4 wherein said library code characters include mode-of-motion characters for modes of motion of said object.

6. The database of claim 5 wherein said time-ordered sequence of said events do not include information regarding movements of said player other than said changes in contact and said modes of motion.

7. The database of claim 5 wherein a mapping between said maneuvers and said library codes is not a one-to-one mapping.

8. The database of claim 5 wherein a mapping between said maneuvers and said library codes is a many-to-few mapping.

9. The database of claim 5 wherein a mapping between said maneuvers and said library codes is a many-to-one mapping.

10. The database of claim 4 wherein said change-in-contact characters include a first change in contact character for initiation of contact, and a second change in contact character for termination of contact.

11. The database of claim 10 wherein said first change in contact character is for a initiation of a non-restraint contact, and said second change in contact character is for termination of said non-restraint contact, and wherein said change-in-contact characters further include a third change in contact character for initiation of a restraint contact, and a fourth change in contact character for termination of said restraint contact.
